(19) United States
(12) Patent Application Publication
(10) Pub. No.: US 2011/0180114 A1
(43) Pub. Date: Jul. 28, 2011

(54) LIQUID AEROSOL PARTICLE REMOVAL METHOD

(76) Inventors: JEFFERY W. BUTTERBAUGH, Eden Prairie, MN (US); Tracy A. Gast, Waconia, MN (US)

(21) Appl. No.: 13/082,676

(22) Filed: Apr. 8, 2011

Related U.S. Application Data
(62) Division of application No. 11/825,508, filed on Jul. 6, 2007.
(60) Provisional application No. 60/819,179, filed on Jul. 7, 2006.

(51) Int. Cl. B08B 3/04; B08B 7/00

(52) U.S. Cl. 134/36

(57) ABSTRACT

Particles are removed from a surface of a substrate by a method comprising causing liquid aerosol droplets comprising water and a tensioactive compound to contact the surface with sufficient force to remove particles from the surface.

This application is a divisional application of U.S. patent application Ser. No. 11/825,508, filed Jul. 6, 2007, entitled “LIQUID AEROSOL PARTICLE REMOVAL METHOD,” which in turn claims the benefit of U.S. Provisional Application Ser. No. 60/819,179, filed Jul. 7, 2006, entitled “LIQUID AEROSOL PARTICLE REMOVAL METHOD” which applications are incorporated herein by reference in their entirety.

### FIELD OF THE INVENTION

The present invention relates to removal of particles from a substrate. More specifically, the present invention relates to the use of a liquid aerosol comprising a tensioactive compound to remove particles from a substrate.

### BACKGROUND OF THE INVENTION

In the processing of microelectronic devices, such as those including semiconductor wafers and other microelectronic devices at any of various stages of processing, substrate surface cleanliness is becoming more and more critical in virtually all processing aspects. Surface cleanliness is measured in many ways and looks at particle presence and/or water marks as contaminants that may affect production of a microelectronic device. Microelectronic devices include, as examples, semiconductor wafers at any stage of processing and devices such as flat panel displays, micro-electrical-mechanical-systems (MEMS), advanced electrical interconnect systems, optical components and devices, components of mass data storage devices (disk drives), and the like. In general, reduction in the quantity of smaller and smaller particles from such substrate surfaces is desired in order to maximize productivity of devices from semiconductor wafers and to meet quality standards as determined for such devices while doing so with effective and efficient processing steps.

Representative steps in wet processing of microelectronic devices include microelectronic device etching, rinsing and drying. As used herein, wet processing includes immersion processing where at least a portion of a microelectronic device is subjected to immersion for a desired period of time and spray processing where process fluids (including rinse fluid) are dispensed to a device surface. Microelectronic device processing typically includes a series of discrete steps such as including a cleaning and/or wet etching step followed by rinsing and drying. These steps may involve the application of a suitable treatment chemical to the substrate surface, e.g., a gaseous or liquid cleaning solution or an etching or oxidizing agent. Such cleaning solutions or etching or oxidizing agents are then preferably removed by a subsequent rinsing step that utilizes a rinsing fluid such as deionized water (DI water) to dilute and ultimately wash away the previously-applied substances. The removal of native oxides on silicon surfaces by sufficient etching typically changes the silicon surface from hydrophilic and renders such HF last-etched surfaces as hydrophobic.

In the case of immersion processing, lifting one or more substrates from a rinse bath (such as a cascade type rinser, as are well known) or lowering the liquid within the vessel can be conducted after the device(s) are adequately rinsed in order to separate the device(s) from the rinse liquid. For spray processing, rinse fluid is dispensed onto a device surface for a determined period while and/or after which a device (or plurality of devices on a carousel in a stack) is rotated or spun at an effective speed to sling the rinse fluid from the device surface. In either immersion or spray processing, it is a goal of such rinse/dry processes to effectively dry a processed device, i.e. to physically remove as much rinse fluid as possible, in order to reduce the amount of fluid that is left after rinsing to be evaporated from the device surface. Evaporation of rinse fluid may leave behind any contaminants or particles that had been suspended within the fluid. For enhanced separation or removal of rinse fluid from microelectronic devices after a rinsing step, techniques have been developed to introduce certain compounds that create a surface tension gradient within the rinse fluid at and near the point of separation of the fluid from the device surface. The effect of this, commonly called the Marangoni effect, is to enhance the ability of the rinse fluid (typically DI water) to shed from the device surface under the action of either separating a device from a liquid bath in immersion separation or spinning a device in the case of spray dispensing. The removal of rinse fluid has been found to be enhanced on either hydrophilic or hydrophobic device surfaces with such techniques. Compounds that affect surface tension and create such a surface tension gradient are known and include isopropyl alcohol (IPA), 1-methoxy-2-propanol, di-acetone alcohol, and ethyleneglycol. See for example, U.S. Pat. No. 5,571,337 to Mohindra et al. for an immersion type vessel and U.S. Pat. No. 5,271,774 to Leenaars et al. for a spin dispensing apparatus, each of which utilize the Marangoni effect as part of the removal of rinse fluid.

An attempt to obtain substrates with better removal of processing fluids from horizontally rotated substrates is described in U.S. Pat. No. 6,568,408 to Mertens et al. Described are methods and equipment that controllably create a sharply defined liquid-vapor boundary, which boundary is moved across the substrate surface along with moving liquid and vapor delivery nozzles. As described in the Mertens et al patent, a surface tension gradient is theoretically created within such boundary by the specific delivery of the vapor to the boundary as such is miscible within the liquid for enhancing liquid removal based upon the Marangoni effect. Such a system may be more effective on hydrophilic surfaces, but adds significantly to the complexity of the system and the manner of control needed to obtain rinsing with adequate rinse fluid removal. The effectiveness of such a system is significantly less for completely hydrophobic surfaces, such as HF last-etched silicon wafers, where a reduction in contaminants, such as small particles, is still desired.

The Leenaars et al U.S. Pat. No. 5,271,774, noted above, describes an apparatus and methods for delivering organic solvent vapor to a substrate surface after it is rinsed and leaves a water film layer on the substrate surface (as such naturally forms on a hydrophilic wafer surface) followed by rotation. Organic solvent vapor is introduced into a process chamber, preferably unsaturated, as controlled by the vapor temperature. FIGS. 2, 3 and 5 of the '774 patent show the sequence of starting with a rinse water film on a substrate surface followed by the film's breaking up into thicker drops as a result of exposure to the organic solvent vapor. Then, the drops are more easily slung from the surface by rotation. Whereas the action of the organic solvent vapor is to create drops from a film of water as such a film layer is possibly provided on a hydrophilic surface, such action would not be required in the situation where a hydrophobic surface is rinsed with water since the same effect is naturally created. For a hydrophobic surface, the rinse water beads into drops on the device surface due to the nature of the surface. Again, there is a need to improve the reduction of contaminants on all surfaces, but in particular, for hydrophobic device surfaces.

For example, it is desirable to increase particle removal efficiency (PRE) while minimizing oxide (e.g., silicon dioxide) loss and damage to the substrate. Conventionally removing particles from microelectronic substrates relies on certain chemical and/or physical action (e.g., megasonics). A drawback of many conventional processes is that they unduly etch the substrate because of the chemical action and/or unduly damage the substrate because of the physical action. For example, conventional single-substrate spray processors can clean substrates while providing relatively low damage because they rely mostly on chemical action, however they tend to unduly etch.

Methods of rinsing and processing devices such as semiconductor wafers wherein the device is rinsed with using a surface tension reducing agent are described in US Patent Application Publication No. 2002/0170573. The method may include a subsequent drying step that preferably incorporates the use of a surface tension reducing agent during at least partial drying. An enhanced rinsing process in a spray processing system is described in U.S. application Ser. No. 11/096,935, entitled: APPARATUS AND METHOD FOR SPIN DRYING A MICROELECTRONIC SUBSTRATE. In the process described therein, a drying enhancement substance is delivered into a gas environment within the processing chamber so that the drying enhancement substance is present at a desired concentration within the gas environment of the processing chamber below its saturation point to thereby set a dew point for the drying enhancement substance. The temperature of the rinse fluid is controlled as dispensed during at least a final portion of the rinsing step to be below the dew point of the drying enhancement substance within the processing chamber.

Methods of processing one or more semiconductor wafers wherein the one or more wafers are processed in the presence of a gaseous antistatic agent are described in US Patent Application Publication No. 2005/0000549. Processing can include performing one or more chemical treatment, rinsing, and/or drying steps in the presence of a gaseous antistatic agent. The step of drying can also include introducing a drying enhancement substance, such as isopropyl alcohol, into the processing chamber.

A number of patents have been issued related to cleaning apparatus configurations where a jet nozzle jets out droplets toward a substrate. The thus provided apparatus is stated to remove contamination adhering to the surface of a substrate. See U.S. Pat. Nos. 5,873,380; 5,918,817; 5,934,566; 6,048,409 and 6,708,903. The jets as disclosed therein include various nozzle configurations. The disclosures contemplate dispensing droplets comprising a liquid that is pure water, or in some cases an additional chemical that is a washing solution (disclosed to be acid or alkali chemicals other than pure water in U.S. Pat. No. 6,048,409 at column 9, line 67 to column 9, line 1).

### SUMMARY OF THE INVENTION

It has been discovered that particles can be removed from a surface of a substrate by a method comprising causing liquid aerosol droplets comprising water and a tensioactive compound to contact the surface with sufficient force to remove particles from the surface. It has been found that the combination of incorporation of a tensioactive compound in the composition of an aerosol droplet with the forceful contact of the aerosol droplet with the surface unexpectedly provides superior particle removal. Thus, on the one hand, the selection of composition to be applied to the substrate surprisingly increases the effectiveness of forceful impact of an aerosol on a substrate for particle removal. Similarly, application of a composition comprising a tensioactive compound to a substrate as a forceful liquid aerosol provides superior particle removal as compared to application of the same composition comprising a tensioactive compound as a gentle rinse. While not being bound by theory, it is believed that the presence of a tensioactive compound in the droplet reduces the surface tension of the droplet composition as it strikes the surface of the substrate, thereby causing the droplet to further spread out on impact with the surface and increasing particle removal effectiveness.

In an embodiment of the present invention, the liquid aerosol droplets comprise water and a tensioactive compound at formation of the droplets. While not being bound by theory, it is believed that the combination of water and a tensioactive compound at formation of the aerosol droplets provide superior incorporation and distribution of the tensioactive compound within the droplets.

In one embodiment of the present invention, the tensioactive compound is incorporated into the liquid of the aerosol droplets prior to formation of the droplets. In a more preferred embodiment, the tensioactive compound is incorporated into the liquid of the aerosol droplets during the formation of the aerosol droplets by impinging at least one stream of a liquid composition comprising water with at least one gas stream of a tensioactive compound vapor-containing gas, thereby forming liquid aerosol droplets comprising water and a tensioactive compound.

In another embodiment of the present invention, the liquid aerosol droplets are formed without the tensioactive compound, and are passed through an atmosphere containing the tensioactive compound prior to contacting the surface.

The present substrate cleaning method is unique because it uses a physical particle removal action without unduly damaging a substrate. Advantageously, such an atomized liquid can be used in microelectronic processing equipment to achieve cleaning results heretofore unavailable, such as reaching exceptional particle removal efficiencies (“PRE”) without losing undesired amounts of oxide and without unduly damaging the substrate. In an embodiment of the present invention, the present method provides improved PRE as compared to like systems that do not use the present method. Thus, a PRE improvement to a complete cleaning process including the method of the present invention of greater than 3%, and more preferably greater than 5%, can be observed.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a schematic diagram of an apparatus that can carry out the process of the present invention.

FIG. 2 is a cross sectional view of a spray bar for carrying out an embodiment of the process of the present invention.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

As noted above, the present invention contemplates removal of particles by causing liquid aerosol droplets comprising water and a tensioactive compound to contact a surface with sufficient force to remove particles from the surface. Because the liquid aerosol droplets are directed to the surface of the substrate with force, particles are removed from the substrate in a manner exceeding the amount of particles that can be rinsed away from the surface by conventional rinsing with the same composition. For example, removal of particles is conventionally tested by first applying silicon nitride particles by exposure of the surface to a spray or bath containing particles. Where this test surface is merely rinsed with a composition as described herein (with no additional cleaning steps being taken as part of a total treatment regimen), the number of particles that are removed is typically below the margin of error of the testing protocol. In contrast, the present method when carried out with no other cleaning steps but with sufficient force in an amount effective to remove particles can remove particles in a statistically significant manner, preferably greater than 40%, more preferably greater than 50%, and most preferably greater than 60%.

The substrate having a surface to be cleaned is preferably a microelectronic device requiring a high degree of cleanness, meaning that the surface of the substrate should be substantially free or have a great reduction in the number of undesired particle impurities after performance of the present process. Examples of such substrates include semiconductor wafers at any stage of processing whether raw, etched with any feature, coated, or integrated with conductor leads or traces as an integrated circuit device, and devices such as flat panel displays, micro-electrical-mechanical-systems (MEMS), microelectronic masks, advanced electrical interconnect systems, optical components and devices, components of mass data storage devices (disk drives), lead frames, medical devices, disks and heads, and the like.

The present method can be carried out as part of other treatment processes being performed on the substrate, either before or after any given process. Additional processes that may be performed on the substrate include either immersion process steps, spray process steps or combinations thereof. The present method is essentially a spray process step, and is readily incorporated in a substrate preparation protocol that includes only spray process steps, due to the efficiency in minimizing manipulation procedures by positioning the substrate in a spray process tool configuration and carrying out all treatments in the same configuration. The present method can be carried out in a tool having substrates provided in a single substrate configuration or a configuration for treatment of a plurality of substrates, either in a stack or a carousel array or both.

The substrate is preferably rotated during treatment to provide adequate and preferably uniform exposure to the aerosol droplets during the treatment process. Preferably, the substrate is rotated while it is oriented in a substantially horizontal manner, although it is contemplated that the microelectronic device can be otherwise supported at an angle tilted from horizontal (including vertical). The aerosol droplets can be dispensed to the center area of a rotating microelectronic device or toward one edge or another thereof or anywhere in-between, with it being preferable that a particle removal operation effectively treat the desired surface of the microelectronic device for a determined time period to achieve a clean device in accordance with predetermined conditions.

The liquid aerosol droplets, on contact with the surface, comprise water and a tensioactive compound. In one embodiment, the non-tensioactive compound liquid of the liquid aerosol droplets is the same composition as a conventional rinse fluid that can comprise any fluid that can be dispensed to the microelectronic device surface and that effectively rinses a device surface to reduce contaminants and/or prior applied processing liquid or gas. The liquid is preferably DI water, but optionally may include one or more treatment components, i.e. ingredients to treat the surface. An example of such a liquid composition comprising treatment components is the SC-1 composition, which is an ammonium hydroxide/hydrogen peroxide/water composition.

The tensioactive compound is selected from the group consisting of isopropyl alcohol, ethyl alcohol, methyl alcohol, 1-methoxy-2-propanol, di-acetone alcohol, ethylene glycol, tetrahydrofuran, acetone, perfluorohexane, hexane and ether. A particularly preferred tensioactive compound is isopropyl alcohol.

In an embodiment of the present invention, the tensioactive compound is present in the liquid aerosol droplet at a concentration of from about 0.1 to about 3 vol %. In another embodiment of the present invention, the tensioactive compound is present in the liquid aerosol droplet at a concentration of from about 1 to about 3 vol %.

Liquid aerosol droplets may be formed from any appropriate technique, such as by forcing fluid through a valve under pressure from a propellant, as in a conventional aerosol spray can, or more preferably by impinging streams of liquid or liquid and gas. Examples of nozzles suitable for use in preparing liquid aerosol droplets include those shown in U.S. Pat. Nos. 5,873,380; 5,918,817; 5,934,566; 6,048,409 and 6,708,903.

The gas may be any appropriate gas, including in particular non-reactive or relatively non-reactive gasses such as nitrogen, compressed dry air, carbon dioxide, and the noble gasses such as argon.

In a preferred embodiment, the tensioactive compound is provided to the droplet by incorporation of the compound in the gas. In one embodiment, the liquid aerosol droplets are formed by impinging at least one stream of a liquid composition comprising water with at least one gas stream of a tensioactive compound vapor-containing gas, thereby forming liquid aerosol droplets comprising water and a tensioactive compound. In another embodiment, the liquid aerosol droplets are formed by impinging two streams of liquid compositions, at least one of which comprises water with one gas stream of a tensioactive compound vapor-containing gas, thereby forming liquid aerosol droplets comprising water and a tensioactive compound.

Preferably, the tensioactive compound is present as about 1 to 3 vol % in the gas. Amounts of tensioactive compound higher than about 3% generally introduces handling complications, such as condensation of the compound out of the gas unless the supply lines are heated. Additionally, higher concentrations of tensioactive compounds tend to raise flammability concerns. The tensioactive compound can be incorporated in the gas in any desired manner, such as bubbling the gas through a solution of tensioactive compound.

Alternatively, the tensioactive compound can be provided as an ingredient in the liquid prior to dispensing through the liquid orifices. In this embodiment, the tensioactive compound is preferably provided as a premixed solution provided to the tool in a pre-diluted manner. Alternatively, the tensioactive compound can be supplied to the liquid within the tool and upstream from or at the spray nozzle. This embodiment, however, is less preferred because the tensioactive compound would be necessarily present as a concentrated composition in the tool in a reservoir and in supply lines containing highly concentrated tensioactive compound. The presence of highly concentrated tensioactive compound in the tool is generally less desirable due to flammability and mix control concerns. In one embodiment, the liquid aerosol droplets are formed by impinging at least one stream of a liquid composition comprising water and a tensioactive compound with at least one gas stream, thereby forming liquid aerosol droplets comprising water and a tensioactive compound. In another embodiment, the liquid aerosol droplets are formed by impinging two streams of liquid compositions, at least one of which comprises water and a tensioactive compound with one gas stream, thereby forming liquid aerosol droplets comprising water and a tensioactive compound. In yet another embodiment, the liquid aerosol droplets are formed by impinging two streams of liquid compositions, at least one of which comprises water and a tensioactive compound, thereby forming liquid aerosol droplets comprising water and a tensioactive compound.

In the embodiment of the present invention where the liquid aerosol droplets are formed without the tensioactive compound, an atmosphere containing the tensioactive compound is created in the processing chamber prior to and during formation and direction of the liquid aerosol droplets toward the surface. The atmosphere containing the tensioactive compound is prepared in any manner such as will now be apparent to the skilled artisan. In an embodiment of the present invention, the tensioactive compound is present on the surface of the substrate. In another embodiment of the present invention, the tensioactive compound is present in the atmosphere at a level such that the tensioactive compound condenses on the surface of the substrate. In another embodiment of the present invention, the tensioactive compound is present in the atmosphere at a level below the saturation point, so that condensation of the tensioactive compound on the surface is avoided.

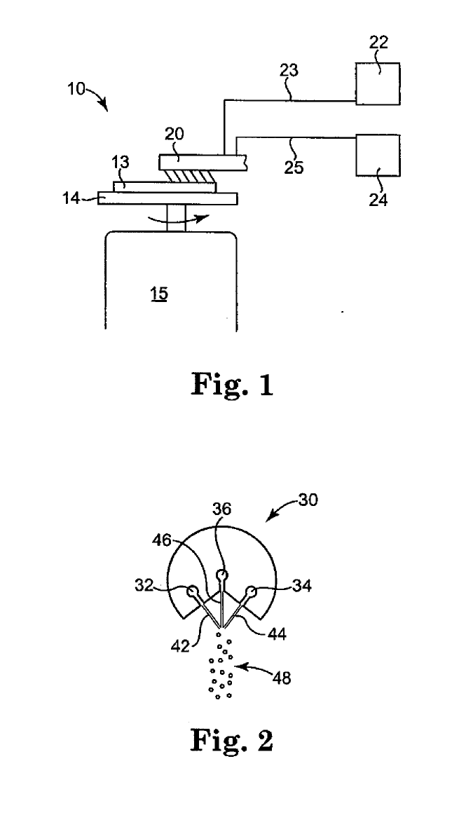

An embodiment of the present invention is schematically illustrated in FIG. 1, which shows a modified spray processing system 10 for carrying out the present invention. In system 10, wafer 13, as a particular microelectronic device for example, is supported on a rotatable chuck 14 that is driven by a spin motor 15. This portion of system 10 corresponded to a conventional spray processor device. Spray processors have generally been known, and provide an ability to remove liquids with centrifugal force by spinning or rotating the wafer(s) on a turntable or carousel, either about their own axis or about a common axis. Exemplary spray processor machines suitable for adaptation in accordance with the present invention are described in U.S. Pat. Nos. 6,406,551 and 6,488,272, which are fully incorporated herein by reference in their entireties. Spray processor type machines are available from FSI International, Inc. of Chaska, Minn., e.g., under one or more of the trade designations MERCURY® or ZETA®. Another example of a single-wafer spray processor system suitable for adaptation in accordance with the present invention is available from SEZ AG, Villach, Austria and sold under the trade designation SEZ 323. Another example of a tool system suitable for adaptation in accordance with the present invention is described in U.S. patent application Ser. No. 11/376,996, entitled BARRIER STRUCTURE AND NOZZLE DEVICE FOR USE IN TOOLS USED TO PROCESS MICROELECTRONIC WORKPIECES WITH ONE OR MORE TREATMENT FLUIDS, filed on Mar. 15, 2006.

Spray bar 20 comprises a plurality of nozzles to direct liquid aerosol droplets onto wafer 13. Liquid is provided from liquid supply reservoir 22 through line 23, and gas is similarly provided from gas supply reservoir 24 though line 25. Spray bar 20 is preferably provided with a plurality of nozzles to generate the aerosol droplets. In a preferred embodiment, nozzles are provided at a spacing of about 3.5 mm in spray bar 20 at locations corresponding to either the radius of the wafer or the full diameter of the wafer when spray bar 20 is in position over wafer 13. Nozzles may optionally be provided at different spacing closer to the axis of rotation as compared to the spacing of the nozzles at the outer edge of the wafer. A preferred spray bar configuration is described in U.S. Patent Application Ser. No. 60/819,133, entitled BARRIER STRUCTURE AND NOZZLE DEVICE FOR USE IN TOOLS USED TO PROCESS MICROELECTRONIC WORKPIECES WITH ONE OR MORE TREATMENT FLUIDS, filed on Jul. 7, 2006; and also U.S. patent application Ser. No. [docket no FSIO202/US], entitled BARRIER STRUCTURE AND NOZZLE DEVICE FOR USE IN TOOLS USED TO PROCESS MICROELECTRONIC WORKPIECES WITH ONE OR MORE TREATMENT FLUIDS, filed on Jun. 20, 2007.

A cross-sectional view of a spray bar 30 is shown in FIG. 2, illustrating a preferred nozzle configuration of the present invention. In this configuration, liquid dispense orifices 32 and 34 are directed inward to provide impinging liquid streams 42 and 44. Gas dispense orifice 36 is located as shown in this embodiment between liquid dispense orifices 32 and 34, so that gas stream 46 impinges with liquid streams 42 and 44. As a result of this impingement, atomization occurs, thereby forming liquid aerosol droplets 48. For purposes of the present invention, a grouping of liquid orifices and gas orifices configured to provide streams that impinge with each other to form a liquid aerosol droplet stream or distribution is considered a nozzle. In one embodiment, liquid dispense orifices 32 and 34 have a diameter of from about 0.020 to about 0.030 inch. In another embodiment, the liquid dispense orifices 32 and 34 have a diameter of about 0.026 inch when located in the spray bar at a position corresponding to the center of the wafer to the mid radius of the wafer, and a diameter of about 0.026 inch from mid-radius of the wafer to the outer edge of the wafer. In an embodiment of the present invention, gas dispense orifice 36 has a diameter of about 0.010 to about 0.030 inch, preferably about 0.020 inch

The location, direction of the streams and relative force of the streams are selected to preferably provide a directional flow of the resulting liquid aerosol droplets, so that the droplets are directed to the surface of a substrate to effect the desired particle removal. In one embodiment, the liquid aerosol droplets are caused to contact the surface at an angle that is perpendicular to the surface of the wafer. In another embodiment, the liquid aerosol droplets are caused to contact the surface of the wafer at an angle of from about 10 to less than 90 degrees from the surface of the wafer. In another embodiment, the liquid aerosol droplets are caused to contact the surface of the wafer at an angle of from about 30 to about 60 degrees from the surface of the wafer. In a preferred embodiment, the wafer is spinning at a rate of about 250 to about 1000 RPMs during contact of the aerosol droplets with the surface of the wafer. The direction of the contact of the droplets with the wafer may in one embodiment be aligned with concentric circles about the axis of spin of the wafer, or in another embodiment may be partially or completely oriented away from the axis of rotation of the wafer. System 10 preferably employs suitable control equipment (not shown) to monitor and/or control one or more of fluid flow, fluid pressure, fluid temperature, combinations of these, and the like to obtain the desired process parameters in carrying out the particular process objectives to be achieved.

The present method may be utilized at any stage of a substrate processing protocol, including prior to or between various treatment steps such as cleaning, masking, etching and other processing steps where removal of particles is desired. In a preferred embodiment of the present invention, the present method using aerosol droplets as described is part of a cleaning step prior to a final rinsing step.

After completion of the particle removal step as described herein, the substrate is preferably rinsed and also subjected to a drying step, which drying step comprises at least a continuation of the rotation of the microelectronic device after rinse fluid dispense is terminated for a determined time period to sling rinse fluid from the device surface. Delivery of drying gas, such as nitrogen that may or may not be heated, is also preferred during a drying step. The drying step is preferably continued for as long as necessary to render the substrate surface sufficiently dry to achieve satisfactory product at desired final contamination levels based upon any particular application. With hydrophilic surfaces, a measurable thin liquid film may still be present on some or all of a device surface. The drying step may be performed with the microelectronic device rotated at the same or at different revolutions per minute as the rinsing step.

### EXAMPLES

Representative embodiments of the present invention will now be described with reference to the following examples that illustrate the principles and practice of the present invention.

### Example 1

Six silicon nitride particle challenged wafers were cleaned with a liquid deionized water aerosol process using a single wafer spin module in a aerosol created by impinging DI water at a flow rate of (1 LPM) with dry N₂ gas stream at a flow rate of 120 slm. Five particle challenged wafers were cleaned with the same aerosol process where the aerosol was created by impinging DI water at a flow rate of (1 LPM) with a 1% IPA/N₂ gas stream at a flow rate of 120 slm. All of the wafers were processed within about a 15 minute time frame. Particle measurements were made for sizes greater than 65 nm using a KLA-Tencor SP1/TBI measurement tool. Particle removal efficiency was improved from an average of 61.7% with dry N₂ to an average of 66.8% with 1% IPA vapor in N₂.

### Example 2

In this example, 200 mm wafers were contaminated with silicon nitride particles by spin deposition and then allowed to sit at ambient conditions to “age” for 24 hours. Five silicon nitride particle challenged wafers were cleaned with a liquid deionized water aerosol process using a single wafer spin module in a aerosol created by impinging DI water at a flow rate of 1 LPM with dry N₂ gas stream at a flow rate of 200 slm. Six particle challenged wafers were cleaned with the same aerosol process where the aerosol was created by impinging DI water at a flow rate of 1 LPM with a 3% IPA/N₂ gas stream at a flow rate of 200 slm Particle removal efficiency reported in Table 1 is the average across the wafers run under each condition.

TABLE 1

| | | |
|---|---|---|
| | average | |
| Particle size | starting | Particle removal efficiency (%) |

| bin (nm) | counts | N₂ only | N₂ + 3% IPA |
|---|---|---|---|
| 65-90 | 1982 | 62.4 | 76.3 |
| 90-120 | 1364 | 72.2 | 82.9 |
| 120-150 | 739 | 78.1 | 88.4 |
| 150-200 | 640 | 86.1 | 93.2 |
| 200-300 | 994 | 90.2 | 94.9 |
| area | 112 | 57.9 | 83.3 |

All patents, patent applications (including provisional applications), and publications cited herein are incorporated by reference as if individually incorporated. Unless otherwise indicated, all parts and percentages are by volume and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A method of removing particles adhered to a surface of a substrate comprising causing liquid aerosol droplets comprising water and a tensioactive compound selected from the group consisting of isopropyl alcohol, ethyl alcohol, methyl alcohol, 1-methoxy-2-propanol, di-acetone alcohol, ethylene glycol, tetrahydrofuran, acetone, perfluorohexane, and hexane to contact the surface with sufficient physical force to remove particles adhered to the surface, wherein the liquid aerosol droplets are formed by impinging two streams of compositions that originate from separate orifices, one of the impinging streams comprising the tensioactive compound.

2. The method of claim 1, wherein the liquid aerosol droplets are formed by impinging at least one stream of a liquid composition comprising water with at least one gas stream of a tensioactive compound vapor-containing gas, thereby forming liquid aerosol droplets comprising water and a tensioactive compound.

3. The method of claim 1, wherein the liquid aerosol droplets are formed by impinging two streams of liquid compositions, at least one of which comprises water, with one gas stream of a tensioactive compound vapor-containing gas, thereby forming liquid aerosol droplets comprising water and a tensioactive compound.

4. The method of claim 1, wherein the liquid aerosol droplets are formed by impinging at least one stream of a liquid composition comprising water and a tensioactive compound with at least one gas stream, thereby forming liquid aerosol droplets comprising water and a tensioactive compound.

5. The method of claim 1, wherein the liquid aerosol droplets are formed by impinging two streams of liquid compositions, at least one of which comprises water and a tensioactive compound, with one gas stream, thereby forming liquid aerosol droplets comprising water and a tensioactive compound.

6. The method of claim 2, wherein the gas is selected from the group consisting of nitrogen, compressed dry air, carbon dioxide, and argon.

7. The method of claim 3, wherein the gas is selected from the group consisting of nitrogen, compressed dry air, carbon dioxide, and argon.

8. The method of claim 4, wherein the gas is selected from the group consisting of nitrogen, compressed dry air, carbon dioxide, and argon.

9. The method of claim 1, wherein the liquid aerosol droplets are formed by impinging two streams of liquid compositions, at least one of which comprises water and a tensioactive compound, thereby forming liquid aerosol droplets comprising water and a tensioactive compound.

10. The method of claim 1, wherein the tensioactive compound is isopropyl alcohol.

11. The method of claim 1, wherein the liquid aerosol droplets, on contact with the surface, comprise the tensioactive compound at a concentration of from about 0.1 to about 3 vol %.

12. The method of claim 1, wherein the liquid aerosol droplets, on contact with the surface, comprise the tensioactive compound at a concentration of from about 1 to about 3 vol %.

13. The method of claim 1, wherein the liquid aerosol droplets additionally comprise a treatment component.

14. The method of claim 13, wherein the treatment component comprises ammonium hydroxide and hydrogen peroxide.

15. The method of claim 2, wherein the tensioactive compound is present in the gas at a concentration of from about 1 to about 3 vol %.

16. The method of claim 3, wherein the tensioactive compound is present in the gas at a concentration of from about 1 to about 3 vol %.
